(19) United States
(12) Patent Application Publication
(10) Pub. No.: US 2008/0152812 A1
(43) Pub. Date: Jun. 26, 2008

(54) Methods of corrosion prevention and cleaning of copper structures

(76) Inventors: Ming Fang, Portland, OR (US); Steve Keating, Beaverton, OR (US); Vani Thirumala, San Jose, CA (US); Lin Sha, Portland, OR (US); Bruce Beattie, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/644,432

(22) Filed: Dec. 22, 2006

(51) Int. Cl. B05D 3/00; B08B 7/00; C11D 7/00

(52) U.S. Cl. 427/299; 106/14.05; 134/42; 510/175

(57) ABSTRACT

Methods and associated structures of forming a microelectronic device are described. Those methods may comprise forming a thin metal-organic layer on a copper structure, wherein the thin metal-organic layer substantially prevents corrosion of the copper structure, and wherein the thin metal-organic layer comprises an organo-copper compound comprising an alkyl group and a thiol group. In addition, methods of applying a high pH cleaning process using a surfactant to improve surface wetting in a low foaming solution is described.

### BACKGROUND OF THE INVENTION

The removal of various resist and/or polymer materials used in microelectronic processes, such as those used in a dual damascene process, for example, may require a complex clean chemistry. The complex cleaning chemistry may comprise aggressive inorganic and/or organic etchants at high pH value. Copper, which may be used to form interconnecting metal structures within microelectronic devices, may be exposed to such a complex cleaning chemistry during processing, for example, during a wet etch to remove etch polymers and residues deposited during a plasma breakthrough etch.

In some cases, an aggressive cleaning solution may etch the copper material and/or create pinholes in the copper structure. The pinholes may result from localized etch attack by various constituents present in the cleaning solution. Excessive copper loss and pinhole defects in copper interconnect structures may result in open circuit failures, which may result in yield loss during device processing. In addition, failure of the chemistry to wet the surface and to retard foaming may lead to particulate defects and residues.

### BRIEF DESCRIPTION OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIGS. 1a-1c represent structures according to an embodiment of the present invention.

FIG. 1d represents a structure according to an embodiment of the prior art.

FIGS. 2a-2d represent structures according to an embodiment of the present invention.

FIGS. 3a-3b represent flowcharts according to an embodiment of the present invention.

### DETAILED DESCRIPTION OF THE PRESENT INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein, in connection with one embodiment, may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Methods of cleaning a microelectronic structure are described. Those methods may comprise forming a thin metal layer on a copper structure, wherein the thin metal-organic layer substantially prevents corrosion of the copper structure during cleaning, and wherein the thin metal-organic layer comprises an organo-copper compound comprising an alkyl group and a thiol group. Methods of the present invention may significantly decrease corrosion defects that may occur during cleaning processes of copper interconnect structures. In another embodiment, a surfactant may be included to a cleaning solution for cleaning various microelectronic device surfaces, which may decrease foaming and improve wet-ability of a device surface to be cleaned.

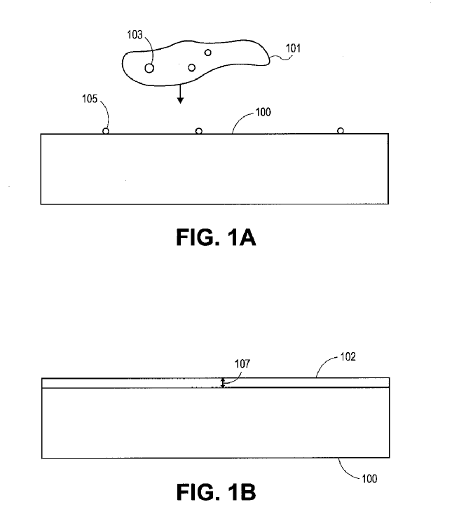

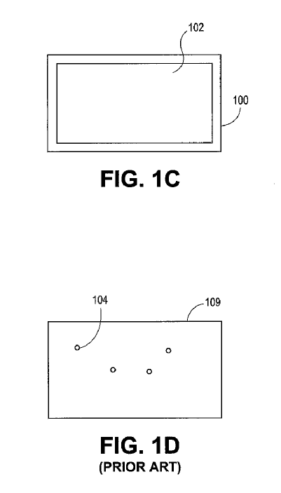

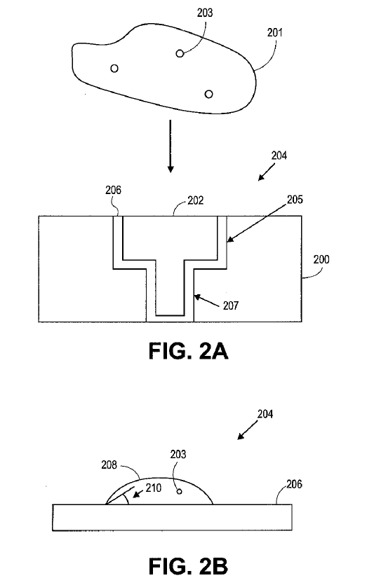

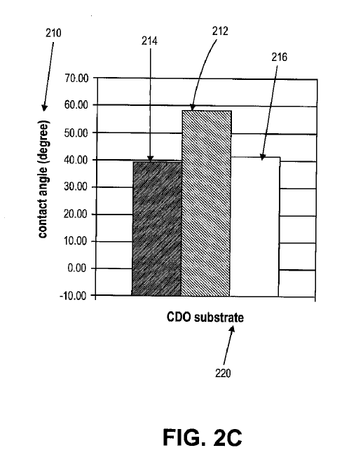

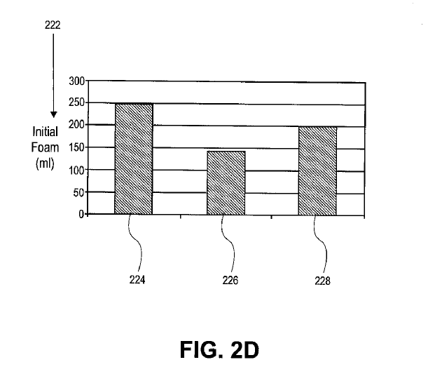

FIGS. 1a-1c illustrate an embodiment of a method of preventing corrosion of conductive structures, including copper conductive structures, for example. FIG. 1a illustrates a cross-section of a portion of a copper structure 100, such as a copper interconnect structure, for example. In one embodiment, the copper structure 100 may comprise a portion of a microelectronic device, such as but not limited to an interconnect structure as are known in the art. In one embodiment, the copper structure 100 may be portion of a damascene structure, such as a conductive layer 202 of a damascene structure 204 as depicted in FIG. 2a, for example.

Referring back to FIG. 1a, the copper structure 100 may comprise residue 105 from a previous process step, such as from an etch stop layer breakthrough step, as is known in the art, wherein the etch stop layer may comprise a dielectric material in some embodiments. In one embodiment, the removal process and/or previous process step may require the subsequent removal of the residue 105, which may comprise resist, sacrificial light absorbing material (SLAM), anti-reflective coating (ARC) and/or etched polymer material in some cases, but may comprise any type of residue 105 that may need to be cleaned from the copper structure 100.

A cleaning process that may utilize a cleaning solution 101 may be used to remove the residue 105. During the cleaning process, the copper structure 100 may be exposed to the cleaning solution 101. In some cases, the cleaning solution 101 may comprise aggressive inorganic and/or organic etchants. In one embodiment, the cleaning solution 101 may comprise a mixture of water and solvent, and may comprise a high pH value, or it may comprise a neutral or low pH in other cases.

The cleaning solution may comprise other constituents, such as but not limited to buffering agents, depending upon the particular application. The cleaning solution 101 may be used to remove at least one of resist, SLAM and polymer material that may be present on a surface of the copper structure 100. In one embodiment, the cleaning solution 101 may be used to remove and/or clean 193-248 nm wavelength resist, as is known in the art.

In one embodiment, the cleaning solution 101 may comprise a corrosion inhibitor 103 which may comprise alkyl chains and SH functional groups. The corrosion inhibitor 103 may be used in alkaline aqueous, solvent, or aqueous-solvent chemistries. In one embodiment, the corrosion inhibitor 103 may comprise an organic molecule comprising a thiol (SH) group. In one embodiment, the corrosion inhibitor 103 may comprise at least one of hexanethiol, heptanethiol, octanethiol, and dodecanethiol. Those skilled in the art may recognize that branched alkyl, hydroxide terminated, and dithol terminated chains will have similar corrosion inhibition.

The corrosion inhibitor 103 may form a thin metal-organic layer 102 that may bond with the copper structure 100 (FIG. 1b). In one embodiment, the metal-organic layer 102 may be formed by a reaction between the copper structure 100 and the corrosion inhibitor 103. Organic compounds that include sulfur atoms may easily form a coordinate bond with copper atoms of the copper structure 100. A stable organo-copper compound formed at the top of copper structure 100 surface may serve to protect the copper structure 100 during the cleaning process. In one embodiment, the thin metal-organic layer 102 may comprise a monolayer of film, and may comprise a thickness 107 of less than about 1-2 nanometers. The thin metal-organic layer 102 may be a continuous layer, i.e., there may be little to no cracks or holes in the thin metal-organic layer 102.

In one embodiment, a thiol containing organic molecule with a low molecular weight may be utilized as the corrosion inhibitor 103, such as a low molecular weight hydrocarbon alkyl chain and a thiol functional group. In one embodiment, the corrosion inhibitor 103 may comprise a thiol containing organic molecule such as CH3(CH2)nSH, where n may comprise 1-14. A corrosion inhibitor 103 comprising such a molecular structure has an enhanced effectiveness in terms of eliminating copper pin holes 104 (FIG. 1d, depicting a top view of a copper structure 109 utilizing a prior art corrosion inhibitor), as well as providing a uniform copper dissolution rate reduction. In some cases, the copper pinholes 104 may form as a result of a reaction between the copper structure 100 and various constituents of the cleaning solution 101. By using the corrosion inhibitor 103 of the various embodiments of the present invention, copper structure 100 pin-holes may be eliminated, as shown in FIG. 1c (top view).

In one embodiment, the concentration of the corrosion inhibitor 103 may comprise less than about 1 percent by weight of at least one of hexanethiol, heptanethiol, octanethiol, and dodecanethiol. In one embodiment, the corrosion inhibitor 103 may comprise a copper removal rate of less than about 1 nm per hour. By using the corrosion inhibitor 103 of the present invention, the reduction of the copper corrosion rate may prevent the localized attack of copper structures that may be exposed during cleaning processes, such as, but not limited to, a clean process after dual damascene patterning, wherein interconnecting copper surfaces may be exposed to the cleaning solution. Thus, the corrosion inhibitor 103 forms a protective film by reaction with the copper structure 100, and as a result, the rate of corrosion of copper may be eliminated.

In another embodiment, a cleaning solution 201 may be utilized to clean a structure 204, such as a structure and/or portion of a microelectronic device, such as a dual damascene structure of a microelectronic device, for example (FIG. 2a). The structure 204 may comprise a high aspect ratio structure, wherein in the aspect ratio may be greater than about 3:1. In some embodiments, the structure 204 may be a portion of a microelectronic device which may include various components such as but not limited to transistors, capacitors, resistors, and the like. In one embodiment, transistors of the microelectronic device may comprise geometries, such as a channel length, for example, of about 35 nm or less.

The structure 204 may comprise a barrier layer 206 and a conductive layer 202, and may further comprise a trench portion 205 and a via portion 207. The structure 204 may also include a dielectric layer 200, such as a CDO (Carbon Doped Oxide) layer for example. In some cases, the CDO layer may be hydrophobic. In one embodiment, the barrier layer 206 and the conductive layer 202 may be formed after the trench portion 205 and the via portion 207 are formed in the dielectric layer 200.

In one embodiment, the barrier layer 206 may be formed on the dielectric layer 200 within the trench 205 and via openings 207, and the conductive layer 202 may then be formed on the barrier layer 206 to fill the trench 205 and via 207 portions. A polishing process may remove portions of the conductive layer 202 and the barrier layer 206 that may be disposed outside and/or above the trench portions 207 of the structure 204, such as by employing a chemical mechanical process, for example. A cleaning solution 201 may be employed to clean the structure 204 after the polishing process has been employed. The cleaning solution may include a corrosion inhibitor, wherein the inhibitor may or may not comprise the various embodiments of the present invention.

In another embodiment, a cleaning process may be utilized to remove SLAM, resist and etched polymer material from a surface of the structure 204. The cleaning process may be employed at various stages of the formation of the structure 200, such as before and/or after the conductive layer 202 is formed, etc. In one embodiment, the cleaning solution 201 used during such a cleaning process may comprise a surfactant 203, which may serve to improve wet-ability of the surface of the structure 204, and may increase the efficiency of removing material from the surface of structure 204. In other embodiments, the cleaning solution 201 may comprise a concentration of a corrosion inhibitor, similar to corrosion inhibitor 103 of FIG. 1a. The corrosion inhibitor may comprise less than about 1 percent by weight of at least one of hexanethiol, heptanethiol, octanethiol, and dodecanethiol, or may comprise other embodiments of the present invention.

In one embodiment, the surfactant 203 may comprise an anionic organic type of surfactant comprising a sulfonate (SO3) functional group. In one embodiment, the surfactant 203 may comprise an alkano polyethylene oxide sulfopropyl ether. In one embodiment, the surfactant 203 may comprise a R—O—(CH₂—CH₂—O)ₙ—CH₂—CH₂—CH₂—SO₃⁻K⁺ molecule, wherein in some cases R may comprise tridecyl or pentadecyl, and wherein n may range from about 1 to 20. In another embodiment, the surfactant 203 may comprise an alkyl benzene sulfonate. In one embodiment, the alkyl benzene sulfonate may comprise a CH₃— (CH2)ₙ—CH₂—C₆H₄—SO₃⁻K⁺ molecule, wherein n may comprise from 8-10 in some cases. In one embodiment, the surfactant 203 may further comprise a potassium salt with or without glycol added.

In one embodiment, the surfactant 203 may be added to a cleaning solution 201 that may be used to clean a dual damascene structure that may comprise 35 nm or smaller geometries. The cleaning solution 203 may comprise an alkaline mixture of water and solvent. In some embodiments, the cleaning solution may comprise a pH value above 7. Such a cleaning solution 201 may be used to remove resist, SLAM and etch polymer materials, for example. The surfactant 203 may be included in the cleaning solution 201 to facilitate the cleaning of very hydrophobic surfaces, such as CDO surfaces. The surfactant 203 may comprise very low foaming characteristics, which may be advantageous when employing spray processing tools during device processing, for example.

FIG. 2b depicts a portion of the cleaning solution 208 comprising the surfactant 203. Including the surfactant 203 into the cleaning solution 201 reduces a contact angle 210 between the portion of the cleaning solution 208 with a surface 206 of the structure 200. In some embodiments, the contact angle 210 may be below about 40 degrees.

FIG. 2c depicts the contact angle 210 between a surface of a CDO substrate 220 and a portion of the cleaning solution surface for various surfactants added to the cleaning solution. In one embodiment, using alkyl benzene sulfonate 214 as the surfactant 203 results in a contact angle of about 40 degrees, while using alkano polyethylene oxide sulfopropyl ether 216 as the surfactant 203 also results in a contact angle of about 40 degrees. A prior art surfactant 212 exhibits a contact angle 210 of about 58 degrees with the CDO surface 220. Thus, the surfactant of the various embodiments of the present invention results in improved performance in terms of reducing the contact angle with a surface to be cleaned, so that wet-ability of the surface is improved, even in the case of a hydrophobic substrate such as CDO

In another embodiment, initial foaming (ml) 222 for various surfactants as applied to a CDO surface is depicted in FIG. 2d. For surfactants comprising sulfonate with alkanol polyethoxylate 226 and alkyl benzene sulfonate 228, initial foaming comprises about 150 ml and about 200 ml respectively, while a prior art surfactant 224 comprises about 250 ml of initial foaming. Thus, the various surfactants of the present invention exhibit improved foaming performance when applied to surfaces to be cleaned, especially with hydrophobic surfaces such as CDO for example. Low foaming facilitates the use of various process cleaning tools, such as spray tools, cascading baths, systems with high ventilation air flows, and systems requiring sensitive air flow measurement instruments, for example.

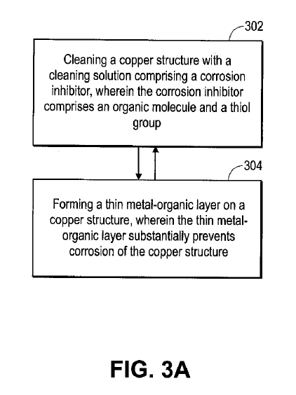

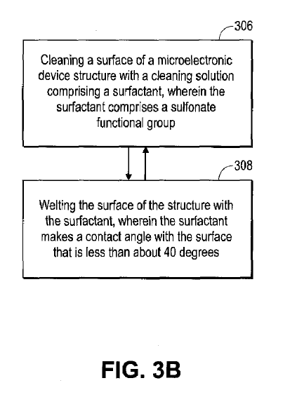

FIG. 3a depicts a flow chart according to an embodiment of the present invention. At step 302, a copper structure may be cleaned with a cleaning solution comprising a corrosion inhibitor, wherein the corrosion inhibitor comprises an organic molecule and a thiol group. At step 304, a thin metal-organic layer may be formed on a copper structure, wherein the thin metal-organic layer substantially prevents corrosion of the copper structure. In some cases, steps 302 and 304 may be simultaneous, or step 304 may preceed step 302.

FIG. 3b depicts a flow chart according to another embodiment of the present invention. At step 306, a surface of a microelectronic device structure may be cleaned with a cleaning solution comprising a surfactant, wherein the surfactant comprises a sulfonate functional group. At step 308, the surface of the structure may be wetted with the surfactant, wherein the surfactant makes a contact angle with the surface that is less than about 40 degrees. In some cases, step 306 and 308 may be simultaneous, or step 308 may preceed step 306.

Although the foregoing description has specified certain steps and materials that may be used in the method of the present invention, those skilled in the art will appreciate that many modifications and substitutions may be made. Accordingly, it is intended that all such modifications, alterations, substitutions and additions be considered to fall within the spirit and scope of the invention as defined by the appended claims. In addition, it is appreciated that certain aspects of microelectronic devices, such as transistor structures, are well known in the art. Therefore, it is appreciated that the Figures provided herein illustrate only portions of an exemplary microelectronic device that pertains to the practice of the present invention. Thus the present invention is not limited to the structures described herein.

What is claimed is:

1. A method comprising:
forming a thin metal-organic layer on a copper structure, wherein the thin metal-organic layer prevents corrosion of the copper structure, and wherein the thin metal-organic layer comprises an organo-copper compound comprising an alkyl group and a thiol group.

2. The method of claim 1 wherein the thin metal-organic layer substantially covers the copper structure.

3. The method of claim 1 wherein forming the thin metal-organic layer comprises cleaning the copper structure with a cleaning solution, wherein the cleaning solution comprises a corrosion inhibitor that reacts with the copper structure to form the thin metal-organic layer.

4. The method of claim 3 wherein the corrosion inhibitor comprises at least one of hexanethiol, heptanethiol, octanethiol, and dodecanethiol.

5. The method of claim 3 wherein the corrosion inhibitor comprises an organic molecule comprising a thiol group.

6. The method of claim 3 wherein the cleaning solution comprises a mixture of water and solvent with a high pH value to remove at least one of resist, SLAM and polymer material.

7. The method of claim 1 wherein forming the thin metal-organic layer prevents the formation of pinholes in the copper structure.

8. The method of claim 4 wherein the corrosion inhibitor comprises a concentration of less than 1 percent by weight of at least one of hexanethiol, heptanethiol, octanethiol, and dodecanethiol.

9. The method of claim 3 wherein the cleaning solution comprises at least one of an alkaline aqueous, solvent, or aqueous-solvent chemistry.

10. The method of claim 3 wherein the pH of the cleaning solution comprises above about 7.

11. The method of claim 3 wherein the copper etch rate of the corrosion inhibitor is about 1 nm per hour or less.

12. The method of claim 1 wherein the thin metal-organic layer comprises a thickness of about 2 nm or less.

13. A method comprising:
cleaning a microelectronic device surface with a cleaning solution, wherein the cleaning solution comprises a surfactant comprising a sulfonate functional group, and wherein a contact angle between the surfactant and the microelectronic device surface comprises about 40 degrees or below.

14. The method of claim 13 further comprising wherein the microelectronic device surface comprises a portion of a microelectronic device structure, wherein the aspect ratio of the microelectronic device structure is greater than about 3:1.

15. The method of claim 13 further comprising wherein an initial foaming of the surfactant is less than about 200 ml.

16. The method of claim 13 further comprising wherein the cleaning solution comprises a pH above about 7.

17. The method of claim 13 wherein the cleaning solution comprises a mixture of water and solvent to remove at least one of resist, SLAM and etch-polymer material.

18. The method of claim 13 further comprising wherein the microelectronic device surface comprises a hydrophobic CDO material.

19. The method of claim 13 further comprising wherein the surfactant comprises an anionic organic material comprising at least one of an alkanol polyethoxylate chain and an alkanol aromatic ring, alkano polyethylene oxide sulfopropyl ether and alkyl benzene sulfonate

20. The method of claim 19 further comprising at least one of potassium salt and glycol.

21. A cleaning solution comprising:
a mixture of water and solvent;
a corrosion inhibitor, wherein the corrosion inhibitor comprises an organic molecule comprising a thiol group; and
a surfactant, wherein the surfactant comprises an anionic organic material.

22. The cleaning solution of claim 21 wherein the cleaning solution is capable of removing at least one of resist, SLAM and polymer material.

23. The cleaning solution of claim 21 wherein the surfactant comprises a concentration of about 0.1 to about 1.0 percent by weight.

24. The cleaning solution of claim 21 wherein the pH of the cleaning solution comprises above about 7.

25. The cleaning solution of claim 21 wherein the corrosion inhibitor comprises a concentration of less than 1 percent by weight of at least one of hexanethiol, heptanethiol, octanethiol, and dodecanethiol.

26. The cleaning solution of claim 21 wherein the copper etch rate of the corrosion inhibitor is about 0.2 nm per hour or less.

27. The cleaning solution of claim 21 wherein the surfactant comprises at least one of an alkanol polyethoxylate chain and an alkanol aromatic ring, alkano polyethylene oxide sulfopropyl ether and alkyl benzene sulfonate, a potassium salt and glycol.
